(19) United States
(12) Patent Application Publication
(10) Pub. No.: US 2018/0108140 A1
(43) Pub. Date: Apr. 19, 2018

(54) METHOD AND ELECTRONIC SYSTEM FOR DETECTING A TARGET, RELATED COMPUTER PROGRAM

(71) Applicant: PARROT DRONES, Paris (FR)

(72) Inventor: Louis-Joseph FOURNIER, Viroflay (FR)

(73) Assignee: PARROT DRONES, Paris (FR)

(21) Appl. No.: 15/729,037

(22) Filed: Oct. 10, 2017

(30) Foreign Application Priority Data
Oct. 13, 2016 (FR) 1659912

(51) Int. Cl. G06T 7/246; G06K 9/00; G06K 9/62

(52) U.S. Cl. CPC G06T 7/248; G06K 9/0063; G06K 9/00369; G06T 2207/30196; G06K 9/6212; G06T 2207/10032; G06K 9/6215

(57) ABSTRACT

This method for detecting a target, using an electronic detection system includes acquiring an image of a scene including the target, the acquired image including a representation of the target, determining at least one segment relative to the target from at least one reference segment relative to a reference representation of the target, and estimating, from the determined segment(s), an area surrounding the representation of the target in the acquired image. At least one of the determined segments is distinct from a contour of the representation of the target and includes at least one point included inside said representation.

### CROSS-REFERENCE TO RELATED APPLICATIONS

This application is based upon and claims the benefit of priority of the prior French Patent Application No. FR 16 59912, filed on Oct. 13, 2016, the entire contents of which are incorporated herein by reference.

### FIELD OF THE INVENTION

The present invention relates to a method for detecting a target using an electronic detection system. The method comprises acquiring at least one image of a scene including the target, each acquired image including a representation of the target; and estimating an area surrounding the representation of the target in the acquired image.

The invention also relates to a non-transitory computer-readable medium including a computer program including software instructions which, when executed by a computer, implement such a detection method.

The invention also relates to an associated electronic system for detecting a target.

The invention offers many applications, in particular for tracking moving targets.

The invention in particular relates to the field of remotely-piloted flying motorized apparatuses, also called drones. The invention particularly applies to rotary-wing drones, such as quadricopters, while also being applicable to other types of drones, for example fixed-wing drones. The invention is then particularly useful when the drone is in a tracking mode to track a given target, such as the pilot of the drone engaging in an athletic activity.

### BACKGROUND

The article titled “Edge Boxes: Locating Object Proposals from Edges” by Zitnick et al. describes the estimation, in an acquired image, of rectangular areas each surrounding an object of interest, and the detection of these objects of interest is based on a search for contours of these objects. A relevance indicator is then calculated based on the difference in the number of contours included in a given area and the number of contours overlapping the border of this given area.

However, such a detection method is not effective enough to track a moving target.

### SUMMARY

The aim of the invention is then to propose a detection system and method that are more effective in tracking a moving target.

To that end, the invention relates to a method for detecting a target, using an electronic detection system, the method comprising:
acquiring an image of a scene including the target, the acquired image including a representation of the target,
determining at least one segment relative to the target from at least one reference segment relative to a reference representation of the target, and
estimating, from the determined segment(s), an area surrounding the representation of the target in the acquired image,

at least one determined segment is distinct from a contour of the representation of the target and includes at least one point included inside said representation,

at least one determined segment preferably being rectilinear.

The detection method according to the invention then makes it possible to find the representation of the target again in a new acquired image by matching reference segments, preferably rectilinear, relative to a reference representation of the target in a prior image and the new determined segments, preferably rectilinear, for the representation of the target in the new acquired image. The method then makes it possible to facilitate the search for the representation of the target in the new acquired image, and also, additionally, makes it possible to calculate a similarity index between the reference representation of the target in the prior image and the representation of the target in the new acquired image.

The detection method according to the invention further makes it possible to recalibrate the position and scale of the representation of the target in the acquired image, and is intended to be used in addition to one or several other algorithms for tracking the target in successively acquired images.

In other words, the detection method according to the invention makes it possible to reframe the scale of the representation of the tracked target from one image to another, for example when producing a video using the image sensor, or even to confirm a new detection of the target after the latter has been lost.

Additionally, the detection method according to the invention also makes it possible to provide a confidence index for the performed detection.

According to other advantageous aspects of the invention, the detection method comprises one or more of the following features, considered alone or according to all technically possible combinations:
the determination of at least one segment relative to the target includes, for at least one reference segment:
   preselecting several segments distinct from a contour of the representation of the target and each including at least one point included inside said representation,
   calculating, for each preselected segment, a deviation between the preselected segment and the reference segment,
   the determined segment then being the segment from among the preselected segments for which the calculated deviation has the lowest value;
each segment includes coordinates for two points in the image and one or several intensity values,

the intensity values preferably being expressed in gray levels;
the calculated deviation depends on intensity values of the preselected segment and the reference segment;
the calculated deviation depends on lengths of the preselected segment and the reference segment;
the calculated deviation depends on positions of the preselected segment and the reference segment;
each segment includes several successive sections between its two ends, with a respective intensity value associated with each section, and during the calculation of the deviation, a unitary deviation is calculated between each section of the preselected segment and each corresponding section of the reference segment, the calculated deviation then depending on the calculated unitary deviations;
the method further comprises:
   calculating a normalized coordinate system from determined segments, the normalized coordinate system having, as center, the barycenter of the determined segments weighted by their length, and the mean length of the determined segments being set as equal to the unit in the normalized coordinate system, and
   updating, in the normalized coordinate system, deviations calculated for each of the determined segments.

The invention also relates to a non-transitory computer-readable medium including a computer program including software instructions which, when executed by a computer, implement a method as defined above.

The invention also relates to an electronic system for detecting a target, comprising:
an acquisition module configured to acquire an image of a scene including the target, the acquired image including a representation of the target,
a determination module configured to determine at least one segment relative to the target from at least one reference segment relative to a reference representation of the target, and
an estimating module configured to estimate, from the determined segment(s), an area surrounding the representation of the target in the acquired image,

at least one determined segment being distinct from a contour of the representation of the target and includes at least one point included inside said representation,

at least one determined segment preferably being rectilinear.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of an electronic system for detecting a target, on board a motorized flying vehicle, piloted by a user;

FIG. 2 is a flowchart of a method for detecting a target according to the invention;

FIG. 3 is a schematic view of a segment, including several successive segments with different gray levels and used for target detection;

FIG. 4 is a view showing the initial step for determining a set of reference segments relative to a reference representation of the target;

FIG. 5 is a view showing the next step for determining a set of reference segments relative to a reference representation of the target;

FIG. 6 is a view showing truncated reference lines for determining a set of reference segments relative to a reference representation of the target;

FIG. 7 is a view showing determining segments relative to the target from reference segments relative to the reference representation of the target; and

FIG. 8 is a another view showing determining segments relative to the target from reference segments relative to the reference representation of the target.

### DETAILED DESCRIPTION

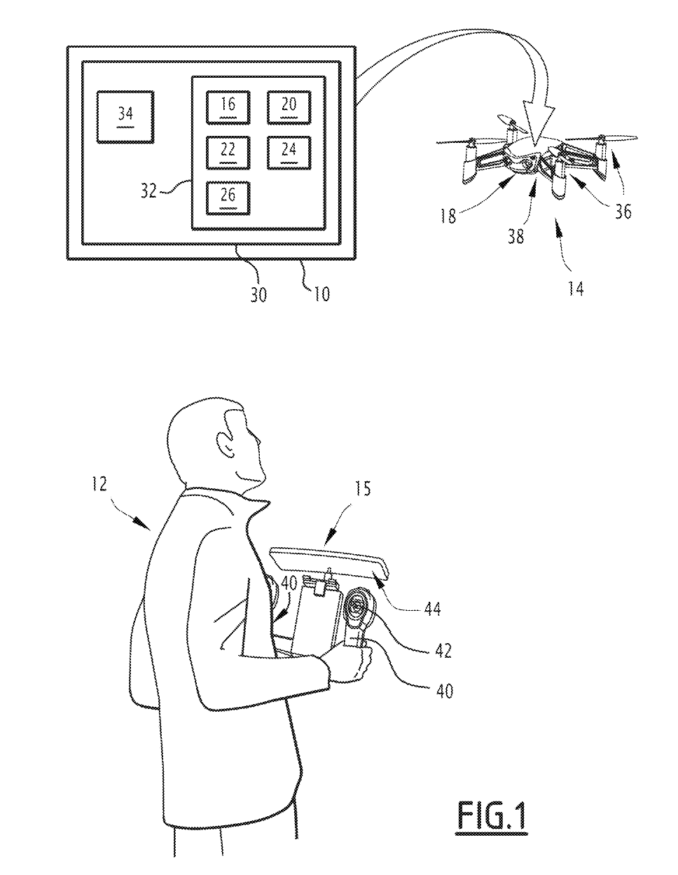

In FIG. 1, an electronic system 10 for detecting a target 12 makes it possible to detect a representation of the target 12 in an acquired image, in particular in an image acquired by a motorized flying vehicle 14, such as a drone, in particular a rotary-wing drone or a fixed-wing drone, the motorized flying vehicle 14 being able to be piloted remotely, in particular via a lever 15.

The electronic detection system 10 is for example on board the motorized flying vehicle 14. Alternatively, the electronic detection system 10 is on board an electronic device, preferably portable, distinct from the motorized flying vehicle 14, the electronic device for example being a smartphone or an electronic tablet, in particular when the lever 15 itself is implemented via the smartphone or the electronic tablet.

The electronic detection system 10 comprises an acquisition module 16 configured to acquire an image of a scene including the target 12, for example by an image sensor 18 equipping the motorized flying vehicle 14. Each acquired image includes a representation of the target 12.

The electronic detection system 10 further comprises a determination module 20 configured to determine at least one segment 21, preferably rectilinear, relative to the target 12 from at least one reference segment 21R relative to a reference representation of the target. The electronic detection system 10 comprises an estimating module 22 configured to then estimate an area surrounding the representation of the target 12 in the acquired image, from the segment(s) 21 determined by the determination module 20.

As an optional addition, the electronic detection system 10 comprises a calculating module 24 configured to calculate a normalized coordinate system from segments 21 determined by the determination module 20, the normalized coordinate system having, as center, the barycenter of the determined segments 21 weighted by their length, and the mean length of the determined segments 21 being set as equal to the unit in the normalized coordinate system.

As another optional addition, the electronic detection system 10 comprises an update module 26 configured to update, in the normalized coordinate system, properties calculated for each of the segments 21 determined by the determination module 20, the updated calculated properties for example being calculated deviations between a determined segment 21 and an associated reference segment 21R.

In the example of FIG. 1, the electronic detection system 10 comprises an information processing unit 30, for example made up of a memory 32 and a processor 34 associated with the memory 32.

The target 12 is for example a person, such as the pilot of the motorized flying vehicle 14, the electronic detection system 10 being particularly useful when the motorized flying vehicle 14 is in a tracking mode to track the target 12, in particular when the pilot of the motorized flying vehicle 14 is engaged in an athletic activity. One skilled in the art will of course understand that the invention applies to any type of target 12, the target 12 preferably being a moving target. The electronic detection system 10 is also useful when the motorized flying vehicle 14 is in a mode pointing toward the target, allowing the motorized flying vehicle 14 still to aim for the target 12, but without moving alone, allowing the pilot the possibility of changing the relative position of the drone of the motorized flying vehicle 14, for example by rotating around the target.

The motorized flying vehicle 14 is known in itself, and is for example a drone, i.e., an aircraft with no pilot on board. The drone is for example a rotary-wing drone, including at least one rotor 36. In FIG. 1, the drone includes a plurality of rotors 36, and is called multi-rotor drone. The number of rotors 36 is in particular equal to 4 in this example, and the drone is then a quadrirotor drone.

The motorized flying vehicle 14 includes the image sensor 18 configured to acquire an image of a scene, the image sensor 18 for example being a front-viewing camera making it possible to obtain an image of the scene toward which the motorized flying vehicle 14 is oriented. Alternatively or additionally, the image sensor 18 is a vertical-viewing camera, not shown, pointing downward and configured to capture successive images of terrain flown over by the motorized flying vehicle 14.

The motorized flying vehicle 14 includes a transmission module 38 configured to exchange data, preferably by radio waves, with one or several pieces of electronic equipment, in particular with the lever 15, or even with other electronic elements to transmit the image(s) acquired by the image sensor 18.

The lever 15 is known in itself, and makes it possible to pilot the motorized flying vehicle 14. In the example of FIG. 1, the lever 15 comprises two gripping handles 40, each being intended to be grasped by a respective hand of the pilot, a plurality of control members, including two joysticks 42, each being arranged near a respective gripping handle 40 and being intended to be actuated by the pilot, preferably by a respective thumb. Alternatively, not shown, the lever 15 is implemented by the smartphone or electronic tablet, as previously described.

The lever 15 also comprises a radio antenna 44 and a radio transceiver, not shown, for exchanging data by radio waves with the motorized flying vehicle 14, both uplink and downlink.

In the example of FIG. 1, the acquisition module 16, the determination module 20 and the estimating module 22, as well as, optionally and additionally, the calculating module 24 and the update module 26, are each made in the form of software executable by the processor 34. The memory 32 of the information processing unit 30 is then able to store acquisition software configured to acquire an image of a scene including the target 12, determination software configured to determine at least one segment 21, preferably rectilinear, relative to the target 12 from at least one reference segment 21R relative to a reference target, and estimating software configured to estimate an area surrounding the representation of the target 12 in the acquired image, from the determined segment(s) 21. As an optional addition, the memory 32 of the information processing unit 30 is also able to store calculating software configured to calculate the normalized coordinate system from determined segments 21, and update software configured to update, in the normalized coordinate system, the calculated properties for each of the determined segments 21, in particular the deviations calculated between a determined segment 21 and an associated reference segment 21R, respectively. The processor 34 of the information processing unit 30 is then able to execute the acquisition software, the determination software and the estimating software, as well as, optionally and additionally, the calculating software and the update software.

In an alternative that is not shown, the acquisition module 16, the determination module 20 and the estimating module 22, as well as, optionally and additionally, the calculating module 24 and the update module 26, are each made in the form of a programmable logic component, such as an FPGA (Field Programmable Gate Array), or in the form of a dedicated integrated circuit, such as an ASIC (Applications Specific Integrated Circuit).

According to the invention, the determining module 20 is configured to determine at least one segment 21, preferably rectilinear, that is distinct from a contour of the representation of the target 12 and includes at least one point included inside said representation.

Each segment 21, 21R is preferably rectilinear, distinct from a contour of the representation of the target 12 and includes at least one point included inside said representation. Each segment 21, 21R preferably includes a majority of points included inside said representation, from among the set of points making up said segment 21, 21R. In other words, each segment 21, 21R is separate from the contour of the representation of the target 12.

The operation of the electronic detection system 10 according to the invention, in particular its determination module 20, will now be described using FIG. 2, illustrating a flowchart of the detection method according to the invention, implemented by computer.

During an initial step 100, the acquisition module 16 acquires an image including the representation of the target 12, for example from the image sensor 18. The acquired image is an image of a scene including the target 12.

During a following step 110, the determination module 20 determines at least one segment 21 relative to the target 12 from at least one reference segment 21R relative to a reference representation of the target 12 in a prior image.

Each segment 21, 21R is preferably rectilinear, and includes the coordinates for two points in the image and one or several intensity values, the intensity values preferably being expressed in gray levels or in color. The coordinates of two points correspond to the ends 112 of the segment 21, 21R. When the intensity values are expressed in color, the intensity values are for example values in the form of three distinct numbers, such as RGB (Red Green Blue) values, the numbers then representing the red, green and blue values.

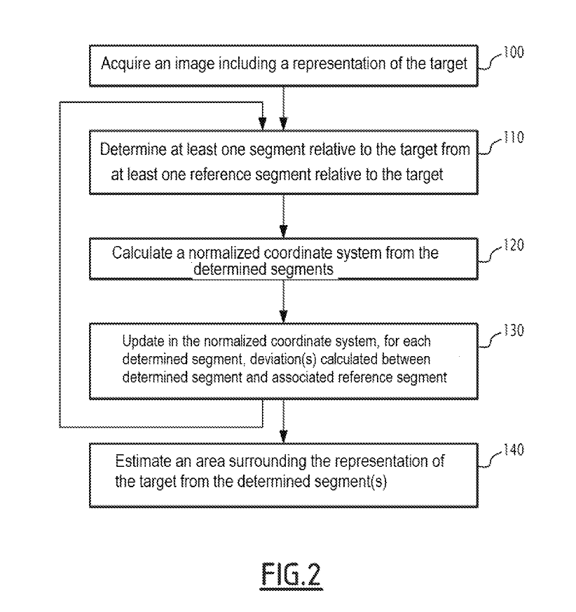

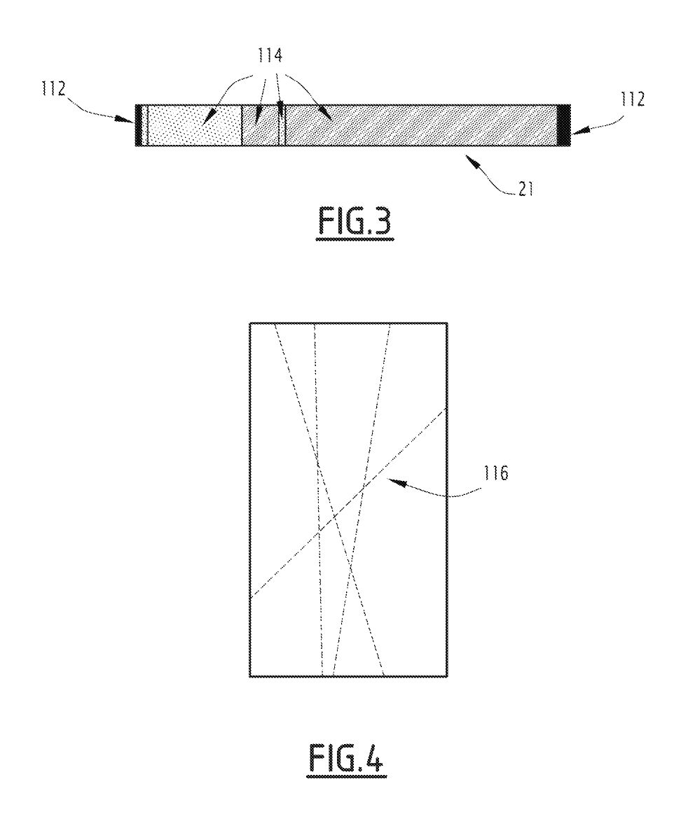

Each segment 21, 21R preferably includes several successive sections 114 between its two ends 112, and each section 114 is associated with a respective intensity value, said intensity value of the section 114 also preferably being expressed in gray levels or in color, as shown in FIG. 3.

In this example, each segment 21, 21R is then defined by the Cartesian coordinates of the ends 112 of the segment 21, 21R in the image, and the successive intensity values, preferably expressed by gray levels or in color, grouped together by areas, or sections 114. The intensity varies substantially from one section 114 to the other, the intensity deviation between two successive sections 114 for example being greater than or equal to 10 on a scale from 0 to 255 in gray levels, also preferably greater than or equal to 20 on said scale of 0 to 255. When the successive intensity values are expressed in color, the intensity deviation between two successive sections 114 is preferably in the form of a combination, for example a linear combination, of the three color values, such as the RGB values.

Each segment 21, 21R has a width of one pixel, or several pixels of the image, as shown in FIG. 3. The skilled person will then understand that each segment 21, 21R has a width which is typically comprised between 1 and 10 pixels, preferably between 1 and 5 pixels. The sections 114 of each segment 21, 21R are preferably determined via a thresholding algorithm, such that each section 114 is associated with a respective intensity value.

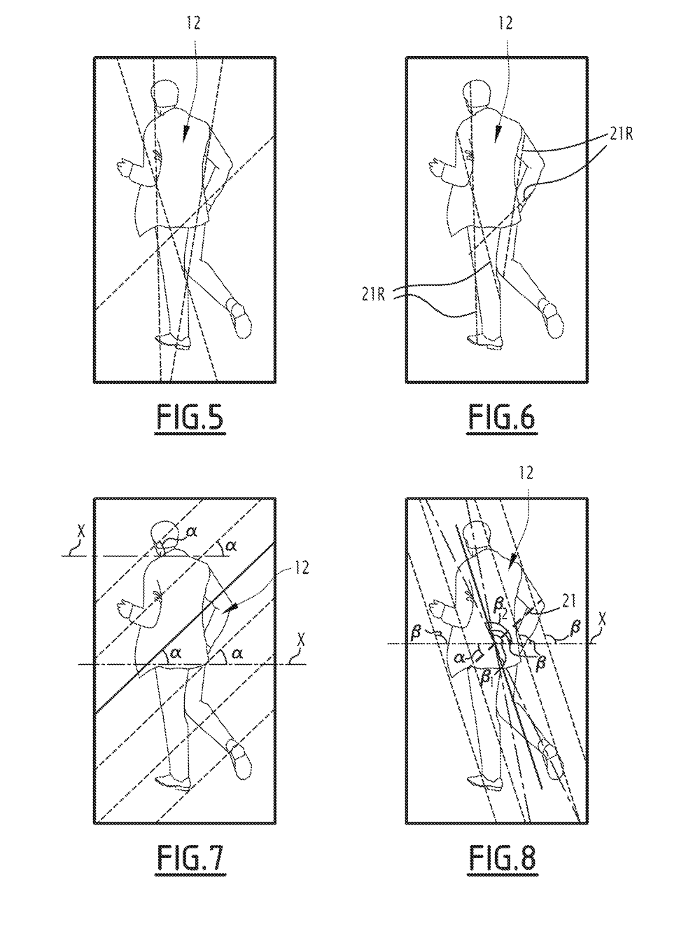

For the prior determination of the reference segments 21R associated with the target 12 in the prior image, the determination module 20 is configured to project a set 116 of reference lines, visible in FIG. 4, on the prior image, as shown in FIG. 5, then to remove the edges of the lines, outside the representation of the target, so as to keep only the segments 21R inside the representation of the target, as shown in FIG. 6. This removal of the edges of the lines that are outside the representation of the target 12 is done via a background/target separating algorithm.

This prior determination of the reference segments 21R is preferably done inside an area, such as a rectangular window, initially selected by the user in an initial image, the initial image then forming the aforementioned prior image.

The set of lines 116 for example results from a random or pseudo-random drawing, in order to obtain a homogenous set in terms of angle values of these lines relative to a reference direction, as well as in terms of position of these lines in the image. The reference direction is for example the horizontal direction X, visible in FIGS. 7 and 8. Alternatively, the reference direction is a vertical direction, not shown, or any other fixed direction identical from one image to the next.

Alternatively, the set of lines 116 is selected according to a selection law, calculated so that a plurality of angle values between the lines of the set 116 and the reference direction is obtained, as well as a plurality of positions of these lines of the set 116.

The segments obtained at the end of the projection of the set of lines 116, then the removal of the edges of the lines that are outside the representation of the target 12, then form the reference segments 21R that will be used to detect a new representation of the target 12 in the new acquired image.

As an optional addition, the reference segments 21R are sequenced according to at least one of the following two criteria. The first criterion is a size criterion, the reference segments 21R preferably being sequenced from the largest segment to the smallest segment. The second criterion is an angle variation criterion between each segment 21R and the reference direction, the reference segments 21R then preferably being sequenced so as to have a minimal angle variation between two reference segments 21R sequenced consecutively at the beginning of the list.

After elaborating this list of reference segments 21R, the list of reference segments 21R preferably remains identical for all of the determinations of new segments in the different images successively acquired.

For the determination of segments 21 relative to the target 12 in the new acquired image, the determination module 20 is configured, for at least one reference segment 21R, to preselect several segments distinct from the contour of the representation of the target 12 and each including at least one point included inside said representation, then to calculate, for each preselected segment, a deviation between the preselected segment and the reference segment 21R, the determined segment 21 then being the segment among the preselected segments for which the calculated deviation has the lowest value.

As an example, for the first segment in the list of reference segments 21R, the determination module 20 preselects several segments in the acquired image, a first preselected segment having the same angle with the reference direction as the first reference segment 21R as well as the same position in the image as the first reference segment 21R, and the other preselected segments corresponding to position offsets of the first reference segment 21R while having the same angle value relative to the reference direction, such as the horizontal direction X, as for the first reference segment 21R, as shown in FIG. 7.

In the example of FIG. 7, the solid line corresponds to the line carried by the first reference segment 21R, and the various dotted lines correspond to the lines offset relative to that associated with the first reference segment 21R, these offset lines forming a same angle α with the reference direction, and being spaced apart from one another by a predefined distance.

The determination module 20 next calculates, for each preselected segment and from the first reference segment 21R, the deviation between the preselected segment and the first reference segment 21R, the segment 21 determined from the first reference segment 21R then being that for which the calculated deviation has the lowest value.

As an optional addition, if the segment thus determined has a deviation value above a predefined threshold, then the segment thus determined is not selected and the determination module 20 reiterates the preselection and deviation calculation steps with the following segment in the list of reference segments 21R.

The deviation calculated between a segment to be evaluated, such as the preselected segment, and the associated reference segment 21R for example depends on intensity values of said segment and the reference segment 21R. The determination module 20 is then configured to calculate an intensity deviation between said segment and the associated reference segment 21R, the calculated intensity deviation preferably being expressed in gray levels or in color.

As an optional addition, during the calculation of the deviation, a unitary deviation is calculated between each section of the segment to be evaluated, such as the preselected segment, and each corresponding section of the reference segment 21R, the calculated deviation then depending on the calculated unitary deviations.

The matching between sections 114 of the reference segment 21R and sections 114 of the segment to be evaluated is for example done by keeping a same order of the sections 114 from one segment to the next, from each first end. Alternatively, the match between sections 114 of the reference segment 21R and sections 114 of the segment to be evaluated does not necessarily respect the order of the sections 114 from one segment to the next.

A unitary intensity deviation dᵥ(z) then for example verifies the following equation:

$${d}_{v} ( z ) = \frac{\vert {v}_{2} - {v}_{1} \vert}{{v}_{ma x}} \qquad ( 1 )$$

where z is an index of the section for which the unitary intensity deviation is calculated,

v₁ is the value of the intensity of said section with index z for the reference segment 21R, preferably expressed in gray levels or in color,

v₂ is the intensity value of said section with index z for the evaluated segment, such as the preselected segment, said value being expressed in the same unit as the value v₁, preferably in gray levels or in color,

vₘₐₓ is the maximum intensity value, according to the unit considered to measure the intensity value, vₘₐₓ for example being equal to 255 for a gray level value expressed in 8 bits.

The value of the calculated unitary intensity deviation dᵥ(z) is then comprised between 0 and 1.

Additionally or alternatively, the deviation calculated by the determination module 20 depends on lengths, on the one hand, of the segment to be evaluated, such as the preselected segment, and on the other hand, of the associated reference segment 21R.

The determination module 20 is then configured to calculate a length deviation between the segment to be evaluated and the associated reference segment 21R.

A unitary length deviation dₗ(z) then for example verifies the following equation:

$${d}_{l} ( z ) = \vert \frac{{l}_{2}}{{L}_{2}} - \frac{{l}_{1}}{{L}_{1}} \vert \qquad ( 2 )$$

where z designates the index of the section considered for the calculation of the unitary length deviation,

l₁ is the length of said section for the reference segment 21R, said length for example being expressed in number of pixels,

L₁ is the total length of the reference segment 21R, expressed in the same unit as the aforementioned length l₁,

l₂ is the length of the section considered for the segment to be evaluated, still expressed in the same unit as the lengths l₁ and L₁, for example in number of pixels,

L₂ is the length of the segment to be evaluated, such as the preselected segment, expressed in the same unit as the lengths l₁, L₁ and l₂.

The value of the unitary length deviation dₗ(z) is also comprised between 0 and 1.

Additionally or alternatively, the deviation calculated by the determination module 20 depends on positions of the segment to be evaluated, on the one hand, and the associated reference segment 21R, on the other hand. The determination module 20 is then configured to calculate a position deviation between the segment to be evaluated, such as the preselected segment, and the associated reference segment 21R.

The position deviation for example depends on a unitary position deviation dₚ(z) between the centers of the two respective areas considered for the segment to be evaluated and the associated reference segment 21R, i.e., a unitary position deviation dₚ(z) between the centers of the sections considered for the segment to be evaluated and the reference segment 21R, relative to the dimension of the segment.

The unitary position deviation dₚ(z) then for example verifies the following equation:

$${d}_{p} ( z ) = \vert \frac{{p}_{2}}{{L}_{2 }} - \frac{{p}_{1}}{{L}_{1}} \vert \qquad ( 3 )$$

where z designates the index of the segment section considered the segment to be evaluated and the reference segment,

p₁ represents the position of the center of the section considered for the reference segment 21R, this position for example being expressed in number of pixels relative to its first end,

L₁ represents the total length of the reference segment 21R, expressed in the same unit as the position p₁, for example a number of pixels,

p₂ represents the position of the section considered for the segment to be evaluated, this position p₂ being expressed in the same unit as the position p₁, and

L₂ is the total length of the segment to be evaluated, expressed in the same unit as the positions p₁ and p₂ and the length L₁.

As an optional addition, a unitary deviation d_{c}(z) calculated by the determination module 20 for the section with index z depends simultaneously on the unitary intensity deviation dᵥ(z), the unitary length deviation dₗ(z) and the unitary position deviation dₚ(z). The calculated unitary deviation d_{c}(z) is then called calculated global unitary deviation, and the calculated global unitary deviation d_{c}(z) is then for example a weighted sum of the three aforementioned deviations dᵥ(z), dₗ(z), dₚ(z), i.e., the intensity deviation dᵥ(z), the length deviation dₗ(z) and the position deviation dₚ(z).

The calculated global unitary deviation d_{c}(z) then for example verifies the following equation:

$$∀ z ∈ Z , {d}_{c} ( z ) = \frac{{k}_{v} \cdot {d}_{v} ( z ) + {k}_{p} \cdot {d}_{p} ( z ) + {k}_{l} \cdot {d}_{l} ( z )}{{k}_{v} + {k}_{p} + {k}_{l}} \\ ∀ z ∈ {Z}^{′} , {d}_{c} ( z ) = 1 \qquad ( 4 )$$

where z designates the index of each considered segment section,

Z designates a set of sections correlated between the segment to be evaluated on the one hand, and the reference segment 21R on the other hand,

Z′ designates the complementary set of sections not correlated between the segment to be evaluated and the reference segment 21R,

kᵥ designates the weight associated with the unitary intensity deviation dᵥ(z),

kₗ designates the weight associated with the unitary length deviation dₗ(z), and

kₚ designates the weight associated with the unitary position deviation dₚ(z).

The calculated global unitary value d_{c}(z) is then comprised between 0 and 1.

Two correlated sections between the segment to be evaluated, on the one hand, and the associated reference segment 21R, on the other hand, are segments for which the value of the deviation calculated between them is low, preferably below a predefined threshold, such as a threshold with a value equal to 0.4. The deviation taken into account for the correlation of two segments 114 is, for example, the calculated global unitary deviation d_{c}(z), as defined according to the first equation from the set of equations (4). Alternatively, the deviation taken into account for the correlation of two segments 114 is the unitary intensity deviation dᵥ(z), the unitary length deviation dₗ(z), the unitary position deviation dₚ(z) or a combination of two of these three unitary deviations dᵥ(z), dₗ(z), dₚ(z).

When a segment to be evaluated is associated with a reference segment 21R, only some of their segments are for example correlated with one another. Alternatively, when two segments are associated, all of their segments are correlated with one another, preferably in pairs.

The deviation calculated by the determination module 20 between the segment to be evaluated and the associated reference segment 21R then depends on each of the calculated global unitary deviations d_{c}(z) between respective sections of said segments. The deviation d_{c} calculated between the two segments is for example a sum of the calculated global unitary deviations d_{c}(z) for each of the sections, preferably a sum weighted by the length L_{réf}(z) of each section with index z in the reference segment 21R.

The calculated deviation then for example verifies the following equation:

$${d}_{c} = \frac{{\sum }_{z} {d}_{c} ( z ) \cdot {l}_{ref} ( z )}{{L}_{ref}} \qquad ( 5 )$$

where l_{réf}(z) designates the length of the segment with index z in the reference segment 21R, and

L_{réf} designates the length of the reference segment 21R, expressed in the same unit as l_{réf}, for example expressed in number of pixels.

The value of the calculated deviation d_{c} is then comprised between 0 and 1.

The calculated deviation then depends on the calculated global unitary deviations d_{c}(z), each global deviation d_{c}(z) being calculated between each section of the segment to be evaluated and each corresponding section of the reference segment 21R.

As an optional addition, after determining at least one segment relative to the target 12 in the new image acquired from the list of reference segments 21R, the electronic detection system 10 goes to step 120 to calculate a normalized coordinate system from the determined segment(s).

During the optional step 120, the calculated module 24 calculates a normalized coordinate system from the determined segment(s), the normalized coordinate system having, as center, the barycenter of the determined segments weighted by their length, and the mean length of the determined segments being equal to the unit in the normalized coordinate system. In other words, the normalized coordinate system is that in which the center has coordinates (0,0), and the mean length of the segments is equal to 1.

After calculating the normalized coordinate system from the determined segments, the detection system 10 goes to the following step 130, also optional, to update, in the normalized coordinate system, the deviations calculated for each of the determined segments.

The update module 26 is then configured to calculate, for each determined segment, a normalized deviation between the reference segment 21R for the reference image and the associated determined segment 21 in the new acquired image. To calculate this normalized deviation, the coordinates of the reference segment 21R on the one hand and the determined segment 21 on the other hand are each expressed in the normalized coordinate system of the set of associated segments between the list of reference segments 21R and the determined segments 21.

The calculated deviation d(r,s) then for example verifies the following equation:

$$d ( r , s ) = \frac{{w}_{p} \cdot {d}_{p} + {w}_{l} \cdot {d}_{l} + {w}_{c} \cdot {d}_{c}}{{w}_{p} + {w}_{l} + {w}_{c}} \qquad ( 6 )$$

where r designates the reference segment 21R and s designates the determined segment 21 in the new acquired image,

dₚ designates the Euclidean distance between the centers of the reference 21R and determined 21 segments, respectively denoted Cᵣ, Cₛ, this distance having a value lower than or equal to 1, and for example verifying the following equation:

dₚ=min(C∥CᵣCₛ∥,1) (7)

dₗ represents the absolute value of the difference of the lengths lᵣ, lₛ of the two segments, also less than or equal to 1, and verifying the following equation:

dₗ=min(|lᵣ−lₛ|,1) (8)

d_{c} represents the deviation previously calculated according to equation (5),

wₚ represents a weight associated with the Euclidean distance dₚ,

wₗ represents a weight associated with the absolute value of the difference in lengths dₗ, and

w_{c} represents a weight associated with the deviation d_{c} previously calculated according to equation (5).

At the end of the update step 130, the detection system 10 returns, if necessary, to step 110 to determine another segment relative to the target 12 in the new image acquired from another reference segment 21R of the list of reference segments 21R, preferably from the following reference segment 21R in said list.

For the determination of another segment relative to the target 12 in the new acquired image from another reference segment 21R from among the list of reference segments 21R, the determination module 20 preselects, from this other reference segment 21R, several segments, the latter being distinct from the contour of the representation of the target 12 and each including at least one point included inside said representation, and preferably rectilinear.

A first preselected segment for example corresponds to the direction carried by the other reference segment 21R, as shown by the continuous dashed line in FIG. 8, forming an angle β with the reference direction, such as the horizontal direction X. Other preselected segments correspond to offsets of this line associated with the other reference segment 21R, while having a same angle value β relative to the line of the reference direction, the offset lines being shown in dotted lines in FIG. 8, and other preselected segments are obtained by performing angle variations from the line associated with the other reference segment 21R, as shown with the dotted lines in FIG. 8, a first of these lines forming an angle β₁ with the reference direction, and another of these lines forming an angle β₂ with the reference direction, the values of the angles β₁ and β₂ being different from that of the angle β.

The determination module 20 next calculates, for each preselected segment, a deviation between the preselected segment and the other reference segment 21R, the determined segment 21 then being that from among the preselected segments for which the calculated deviation has the lowest value. The calculation of the deviation is done as previously indicated for the calculation of the deviation when determining the first segment.

After each determination of the other segment(s) relative to the target 12 from additional reference segments 21R from the list of reference segments 21R, the calculating module 24 optionally calculates the normalized coordinate system obtained from the set of determined segments, then the update module 26 optionally updates, during step 130, the calculated deviations for each of the determined segments in the new normalized coordinate system calculated during the prior optional step 120, as previously described.

As an optional addition, at the end of the determination 110, calculating 120 and update 130 steps, the electronic detection system 10 is further configured to perform filtering from among the set of determined segments 21, in order to verify that the position and length of the segments 21 determined in the normalized coordinate system remain close to those of the associated reference segment 21R for each determined segment, i.e., have respective deviation values below predetermined respective thresholds. When one of the determined segments 21 has, after updating deviations in the normalized coordinate system, deviation values above the predefined threshold, i.e., the position and/or length of said determined segment 21 are no longer close enough to those of the associated reference segment 21R, then the electronic detection system 10 is configured to eliminate said segment 21 from the set of segments 21 determined thus far.

The electronic detection system 10 then goes to step 140 in order to estimate an area surrounding the representation of the target 12 in the new acquired image, from the segment(s) determined during each step 110. The estimating module 22 is then configured to estimate, from the segment(s) 21 previously determined in the new acquired image, the geometric coordinates of an area, such as a polygonal area, preferably a rectangular area, surrounding the representation of the target 12 in the new acquired image.

The estimating module 22 is for example configured to project the area initially determined by the user, from the initial image toward the new acquired image, by changing coordinate systems, going from the initial coordinate system associated with the initial image to the last normalized coordinate system calculated during step 120.

Additionally or alternatively, the estimating module 22 is also configured to calculate one or several sides of the area surrounding the representation of the target 12 from the determined segment(s) 21. To that end, the estimating module 22 is for example configured to calculate, for at least one direction, for example for each of the directions from among the top, right, bottom, left directions, the median of the ends of a certain number of segment(s) furthest in this direction. The number of segments used to calculate this median is for example equal to 3. The area surrounding the representation of the target 12 then for example has the frame as border, each edge of which has the median corresponding to its direction as position.

As an optional addition, the determination module 20 is further configured to calculate a similarity index Iₛ between the list of reference segments 21R obtained from the reference representation of the target 12 in the initial image, on the one hand, and the set of segments 21 determined in the new acquired image, on the other hand. This similarity index Iₛ is for example calculated from a sum of the deviations between each reference segment 21R and each associated determined segment 21, or the value 1 when no segment has been found matching a reference segment 21R. This sum of the deviations is preferably a weighted sum of the deviations, the weighting being done based on the length of the reference segment 21R. The longest segments are then those that have the most weight in calculating this similarity index Iₛ via said weighted sum.

The similarity index Iₛ then for example verifies the following equation:

$${I}_{S} = \frac{{\sum }_{n = 1}^{N} d ( {r}_{n} , {s}_{n} ) \cdot {l}_{{r}_{n}}}{{\sum }_{n = 1}^{N} {l}_{{r}_{n}}} \qquad ( 9 )$$

where n is the index of the considered segment, and N is the number of segments 21R from the list of reference segments 21R,

rₙ designates the reference segment 21R with index n and sₙ designates the determined segment 21 with index n,

d(rₙ, sₙ) represents the normalized deviation between the reference segment 21R with index n and the determined segment 21 with index n, and

lₘ represents the length of the reference segment 21R with index n.

The similarity index Iₛ then provides an indication of the similarity between the determined segments 21 on the one hand, and the reference segments 21R initially identified on the other hand.

As an optional addition, the area surrounding the representation of the target 12 is estimated during step 140 only when the similarity index Iₛ thus calculated has a low enough value, i.e., below a predefined value threshold, the value of this threshold for example being equal to 0.5.

Otherwise, when the similarity index Iₛ thus calculated has too high a value, the estimating module 22 does not estimate any area surrounding the representation of the target 12, so as not to estimate an area that would have an excessively high likelihood of being erroneous, and the estimating step 140 is then not carried out, the method returning directly to step 100 in order to acquire a new image, for tracking of the target 12.

Thus, the electronic detection system 10 and the detection method according to the invention make it possible to find the target 12 again in any acquired image, from the list of reference segments 21R. This list is for example obtained from a prior identification of the target 12 done by the user in an initial image, the user then selecting an area, preferably rectangular, surrounding the target 12.

The electronic detection system 10 and the detection method according to the invention in particular make it possible to reframe the scale of the tracked target 12, and to confirm a new detection of the target 12 when the latter has been temporarily lost in one or several successively acquired images.

The representation of the target 12 is thus characterized by a set of segments 21, 21R, preferably rectilinear, as previously described, these segments 21, 21R each separating the target 12 into sections with different values according to a specific orientation. This characterization then makes it possible to relocate the target more effectively in the successively acquired images by allowing a certain flexibility in any deformations of the target, in particular due to a change in viewing angle.

The electronic detection system 10 and the detection method according to the invention are further particularly effective in terms of calculating time, the calculations done being calculations in a single dimension through the use of the segments 21, 21R, preferably rectilinear.

Calculating the deviations between the reference segments 21R and the determined segments 21 also based on the position and/or relative size of the segments 21, 21R makes it possible to have a faster convergence toward the representation of the target 12 sought in the new acquired image.

The electronic detection system 10 and the detection method according to the invention then enable an accurate estimate of the area surrounding the representation of the target 12 in nearly half of all cases, and in the other half of cases, the representation of the target is not found, i.e., is not estimated, while having a very low false positive rate, i.e., area estimates done incorrectly, or erroneously, the false positive rate being equal to about 5%.

The inventors have further observed that the detection method according to the invention is particularly effective when the target 12 is highly contrasted with a relatively simple background, which then allows a more precise determination of the ends of the segments using the background/target separating algorithm.

The use of different weight values to calculate the different deviations previously described, and thresholds to define an acceptable maximum, as needed, for the obtained values further makes it possible to decrease the false positive rate.

When the area estimated by the estimating module 22 is slightly noisy, the estimating module 22 is further configured to apply a filter of the low-pass type to the estimated area, in order to smooth the obtained result.

One can thus see that the electronic detection system 10 and the detection method according to the invention make it possible to improve tracking of the moving target 12, in particular by allowing more effective recalibration of the position and/or scale of the representation of the target 12 in the new acquired image, the method further being able to be reiterated for each new acquired image, in order to perform this recalibration for each new acquired image.

This detection method according to the invention further has the advantage of directly obtaining an estimate of the area surrounding the representation of the target 12 in the acquired image, without having to test a plurality of offset areas in the acquired image successively, as is done with a known sliding window technique.

1. A method for detecting a target, the method being implemented by an electronic detection system and comprising:
acquiring an image of a scene including the target, the acquired image including a representation of the target;
determining at least one segment relative to the target from at least one reference segment relative to a reference representation of the target; and
estimating, from the at least one determined segment, an area surrounding the representation of the target in the acquired image;
wherein the at least one determined segment is distinct from a contour of the representation of the target and includes at least one point included inside said representation.

2. The detection method according to claim 1, wherein the at least one determined segment is rectilinear.

3. The detection method according to claim 1, wherein the determination of at least one segment relative to the target includes, for at least one reference segment;
preselecting several segments distinct from a contour of the representation of the target and each including at least one point included inside said representation;
calculating, for each preselected segment, a deviation between the preselected segment and the reference segment; and
the determined segment then being the segment from among the preselected segments for which the calculated deviation has the lowest value.

4. The detection method according to claim 1, wherein each segment includes coordinates for two points in the image and one or several intensity values.

5. The detection method according to claim 3, wherein each segment includes coordinates for two points in the image and one or several intensity values, and
wherein the calculated deviation depends on intensity values of the preselected segment and the reference segment.

6. The detection method according to claim 3, wherein the calculated deviation depends on lengths of the preselected segment and the reference segment.

7. The detection method according to claim 3, wherein the calculated deviation depends on positions of the preselected segment and the reference segment.

8. The detection method according to claim 3, wherein each segment includes several successive sections between its two ends, with a respective intensity value associated with each section, and
wherein, during the calculation of the deviation, a unitary deviation is calculated between each section of the preselected segment and each corresponding section of the reference segment, the calculated deviation then depending on the calculated unitary deviations.

9. The detection method according to claim 1, wherein the method further comprises:
calculating a normalized coordinate system from the determined segments, the normalized coordinate system having, as center, the barycenter of the determined segments weighted by their length, and the mean length of the determined segments being set as equal to the unit in the normalized coordinate system, and
updating, in the normalized coordinate system, deviations calculated for each of the determined segments.

10. A non-transitory computer-readable medium including a computer program comprising software instructions which, when executed by a computer, carry out a method according to claim 1.

11. An electronic system for detecting a target, comprising:
an acquisition module configured to acquire an image of a scene including the target, the acquired image including a representation of the target,
a determination module configured to determine at least one segment relative to the target from at least one reference segment relative to a reference representation of the target, and
an estimating module configured to estimate, from the determined segment(s), an area surrounding the representation of the target in the acquired image,
at least one determined segment being distinct from a contour of the representation of the target and includes at least one point included inside said representation.
